(19) United States
(12) Patent Application Publication
(10) Pub. No.: US 2008/0173784 A1
(43) Pub. Date: Jul. 24, 2008

(54) COLLAPSIBLE BEDSIDE MONITOR BEDRAIL HOOK

(75) Inventors: Martin K. MASON, Andover, MA (US); Ed STAMM, Roswell, GA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/018,221

(22) Filed: Jan. 23, 2008

Related U.S. Application Data
(60) Provisional application No. 60/886,311, filed on Jan. 24, 2007.

(51) Int. Cl. F16M 11/00

(52) U.S. Cl. 248/685

(57) ABSTRACT

An integral handle (12) is formed in a portable patient monitoring device (10) to minimize device size and to provide a storage cavity for a stowable bedrail hook assembly (30) mounted to the device (10). A handle cavity (14) extends through a top side (16) of the device casing and out through a back side (18) of the casing to accommodate a human hand and permit an operator to grasp the integral handle (12). The hook assembly (30) has a generally U-shaped crossbar (32) that is inserted to mounting brackets (40) secured to the back side (18) of the device (10). Hook portions (34) having a curvature generally congruent to the interior of the handle cavity (14) extend from the crossbar (32) and stow inside the handle cavity (14) as the crossbar (32) rests against the back side (18) of the device when the hook assembly is stowed. The hook assembly (30) is pivoted approximately 180 degrees out and up from the handle cavity (14) to an active position for use, and the hook portions (34) are placed over a bedrail to mount the monitor.

### CROSS REFERENCE TO RELATED APPLICATIONS

This application claims the benefit of U.S. provisional application Ser. No. 60/886,311 filed Jan. 24, 2007, which is incorporated herein by reference.

### BACKGROUND

The present application finds particular application in patient healthcare systems, particularly involving portable healthcare monitors. However, it will be appreciated that the described technique may also find application in other portable devices, other monitoring scenarios, or other device fastening or securing techniques.

Vital sign and/or bedside monitors are positioned for use in a variety of manners, such as by wall mount, table mount, rolling stand, etc. Such mounting strategies permit a monitor to be used in stationary as well as transport situations. Such monitors need to be easily movable and securable in order to permit monitoring of a patient to be initiated quickly and in a variety of locations. Some monitoring devices are designed to be transported to a patient's location and hung or otherwise secured to a bedrail or the like. Typically, such a monitor employs a hook that is permanently affixed to the monitor, which can be bulky and obtrusive. For instance, such extending hooks may be plastic hooks molded as part of the monitor case, metal or plastic hooks screwed into the case, etc.

Other types of “collapsible” hooks have been designed for portable devices, but these hooks typically dangle and/or are inconvenient when not in use. Still other mechanisms involve one or more hooks that slide into and out of receiving bores in the back of a portable monitor. However, the receiving bores are difficult to clean and can harbor bacteria or germs that can be highly undesirable and detrimental to the patient for which the monitoring device is employed.

The present application provides new and improved portable device securing systems and methods, which overcome the above-referenced problems and others.

### BRIEF SUMMARY OF THE INVENTION

In accordance with one aspect, a system for supporting a portable monitoring device on a patient's bedrail includes a portable patient monitoring device with an integral handle formed within a casing of the portable patient monitoring device. The device further includes a handle cavity that receives a human hand, the handle cavity extending through a top side of the portable patient monitoring device, around a quadrant of the handle through the device, and through a back side of the portable patient monitoring device to permit an operator to grasp the handle.

In accordance with another aspect, a method of deploying the portable patient monitoring device includes carrying the portable device with a hook assembly stowed in the handle cavity, pivoting the hook assembly outward from the handle cavity, and placing the hook over a structure to hang the portable patient monitoring device.

One advantage resides in the integral device handle, which reduces overall device size and facilitates storage, transport, packaging, and the like.

Another advantage resides in the bedrail hook assembly that stows out of the way when not in use, which further facilitates minimizing device size for packaging, storage, transport, or occupying premium space at a patient's bedside during an emergency.

Still further advantages of the subject innovation will be appreciated by those of ordinary skill in the art upon reading and understand the following detailed description.

### BRIEF DESCRIPTION OF THE DRAWINGS

The innovation may take form in various components and arrangements of components, and in various steps and arrangements of steps. The drawings are only for purposes of illustrating various aspects and are not to be construed as limiting the invention.

FIG. 1 illustrates a portable patient monitoring device that includes an integral handle that is molded into the casing of the device, with a cavity that extends through a top side of the device and through a back side of the device.

FIGS. 2A and 2B illustrate a side-view and an end-on view, respectively, of a stowable bedrail hook assembly for a portable device that permits a user to hang a portable device when necessary and to store the hook assembly compactly and unobtrusively when not in use.

FIG. 3 shows a top-down view of the stowable hook assembly, with the U-shaped crossbar and lateral end portions in the same plane, and with the hook portions perpendicular to the crossbar.

FIG. 4 illustrates an askew view of the bedrail hook assembly.

FIG. 5 is an exploded view of the stowable bedrail hook and mounting bracket, with which the hook assembly is mounted to a portable device.

FIG. 6 shows a rear-view of a system including the stowable bedrail hook assembly mounted to the portable device using the mounting brackets.

FIG. 7 is a cross-sectional view of the portable device and mounted hook assembly.

FIG. 8 illustrates a side-view of the portable device with mounted hook assembly in an active position and secured to a structure, such as a bedrail or the like.

FIG. 9 illustrates a method of operating the system.

FIG. 10 illustrates a front view of a portable monitor with an integral handle, such as can be employed with a stowable hook assembly.

### DETAILED DESCRIPTION OF THE INVENTION

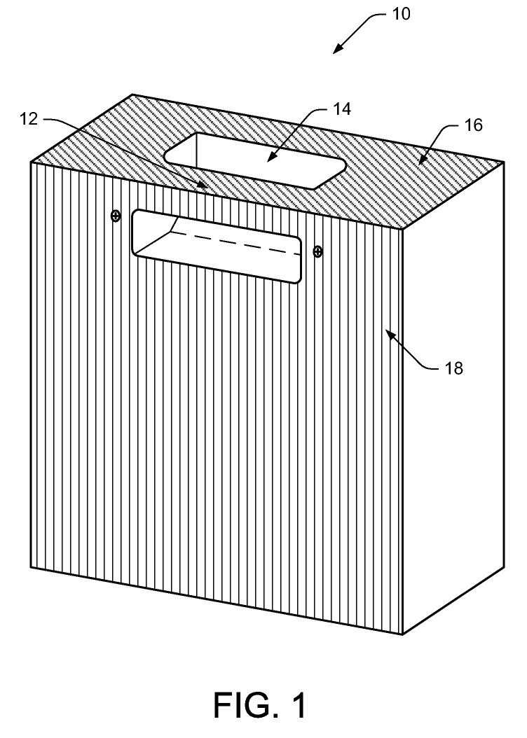

FIG. 1 illustrates a portable patient monitoring device 10 that includes an integral handle 12 that is molded into the casing of the device 10, with a cavity 14 that extends through a top side 16 of the device and through a back side 18 of the device. The monitoring device, according to some embodiments, is a patient monitoring device, such as is utilized to monitor vital signs and/or other patient health status information. For example, the monitoring device can include functionality related to monitoring blood pressure, pulse, respiration rate, blood-oxygen levels (SpO₂ levels), carbon dioxide levels, temperature (patient and/or or ambient). According to other examples, the monitoring device can and/or include an electrocardiogram (ECG, EKG) device, a defibrillation device, or any other suitable device that is used for monitoring a patient's status and/or for performing an action on a patient.

The cavity 14 is designed to accommodate a human hand, and may be made large enough to permit a large human hand to pass through the cavity to grip the handle. According to various features, the cavity is large enough for a gloved hand, even with a thick glove such as may be worn by a firefighter or other rescue personnel. Additionally, the cavity (and thus the handle 12) is approximately centered between lateral sides of the device to ensure approximately even weight distribution. It will be appreciated that the device is not drawn to scale, and that the length of the cavity is not limited to the depicted length, but rather may extend to either or both lateral sides of the device so long as there is sufficient casing material at either side to support the weight of the device. According to other aspects, the handle and the cavity may be offset to one side or the other to compensate for an uneven weight distribution within the device. In any case, the handle is positioned such that the center of mass of the device is approximately centered below the center of the handle.

The handle 12 can be any desired shape, including but not limited to columnar (rectangular), quarter-round (e.g., substantially flat on the top and back sides, and rounded on the interior side), triangular) e.g., having an interior side that is a hypotenuse connecting the ergonomically molded to complement a human hand, etc. By forming the handle integrally with the casing of the device 10, the device is streamlined to facilitate efficient storage when not in use, efficient packaging for shipment or storage, and the like. Additionally, the integral handle design reduces the risk of accidental damage to the device such as can occur upon inadvertent contact to a conventional protruding handle. In this manner, the device is more efficiently stored, shipped, and hand-carried than conventional devices.

It will be understood that although the device is described herein in the context of a portable medical monitoring device, the integral handle design and stowable hook design (described below) have application in a wide variety of devices, and may thus be employed for any suitable device that can be carried and hung (e.g., portable televisions, radios, baby monitors), as will be appreciated by those of skill.

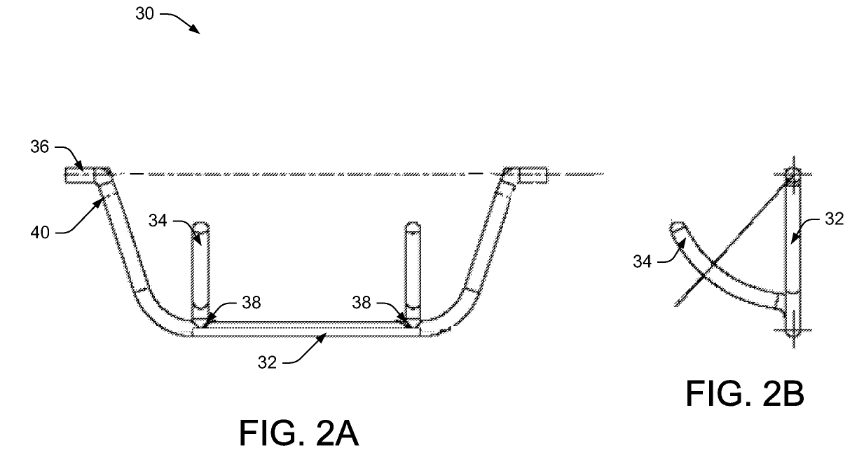

FIGS. 2A and 2B illustrate a side-view and an end-on view, respectively, of a stowable bedrail hook assembly 30 for a portable device that permits a user to hang a portable device when necessary and to store the hook assembly compactly and unobtrusively when not in use. Additionally, the hook assembly is designed to stow away in the integral handle cavity 14 described above without requiring deep or narrow storage cavities that can harbor bacteria and are otherwise difficult to sanitize. The stowable bedrail hook assembly facilitates quickly securing a monitoring device to a bedrail of a patient's bed without unnecessary protruding parts, which can be detrimental during an emergency at the patient's bedside or during transport, when space is at a premium.

The bedrail hook assembly 30 can be fashioned from molded plastic, formed or bent metal or wire, or any other suitable material. According to some embodiments, the hook assembly 30 is formed of bent stainless steel wire with a diameter in the range of approximately ⅛ inches (3 mm) to approximately ⅜ inches (10 mm). According to other examples, the diameter of the stainless wire is approximately 3/16 inches (4 mm), ¼ inches (6 mm), or 5/16 inches (8 mm), although other suitable wire diameters are possible. A curved hook portion 34 protrudes in a substantially perpendicular orientation relative to the crossbar. The cross bar generally has a U-shape, with symmetrical bends at both ends of a bottom portion of the U-shape, whereby the sides of the U-shape are angled approximately 50 degrees to approximately 70 degrees from the bottom portion of the U-shaped crossbar. According to a more specific example the sides of the U-shaped crossbar are at an approximately 60-degree angle from the bottom of the crossbar, or approximately 30 degrees from perpendicular.

The crossbar 32 further includes a lateral end portion 36 at each end, which is parallel to the bottom portion of the U-shape, and is oriented along a pivot axis about which the stowable hook assembly 30 rotates between a stored position and an active position. Additionally, the hook portions 34 of the assembly are welded to the bottom portion of the crossbar at weld points 38. It will be appreciated that other hook orientations are possible, and that the subject innovation is not limited to hook portions welded at points 38. Rather, the assembly may comprise any number of hooks (e.g., 1, 2, 3, 4, . . . , N, where N is an integer). According to other examples, the hook portion 34 is a continuous hook that spans the length of the bottom portion of the crossbar, and is formed by bending or curving a thin sheet of stainless steel.

According to other features, the stowable bedrail hook assembly 30 is coated using a material that facilitates maintaining a sanitary surface and/or increasing a coefficient of friction between the assembly and the bedrail. For instance, the assembly may be painted using a suitable medical-grade paint to improve aesthetics and to protect the assembly. Additionally or alternatively, the assembly is coated in rubber, plastic, epoxy, or the like, to permit easy cleaning and to prevent slippage when the bedrail hook is deployed to secure an associated monitor to a patient's bedrail. A polymer coating (e.g., a plastic or the like) or paint applied to the assembly covers the hook portions and crossbar up to point, such that the lateral ends 36 are left bare to facilitate easy pivoting when the lateral ends are secured in a mounting bracket attached to a portable monitor.

According to some examples, the overall width of the assembly 30 is approximately 17 cm to approximately 20 cm. In some cases the assembly is approximately 18.5 cm in length. The lateral end portions 36 of the assembly are approximately 10 mm to approximately 12 mm in length, and the hook portions 34 are curved in an arc with a radius of approximately 50 mm to approximately 54 mm from the pivot axis that extends through the lateral end portions 36 of the assembly. It will be appreciated that the figures herein are not drawn to scale, and that the foregoing dimensions are provided to illustrate examples of relative sizes an orientations of components of the hook assembly 30, while the assembly and/or the portable device handle described herein are not limited to such dimensions.

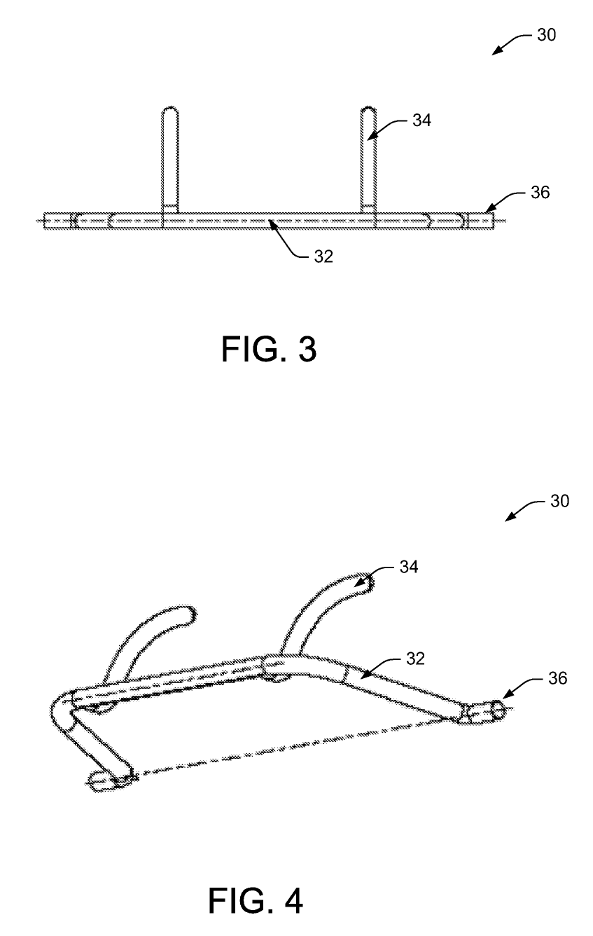

FIG. 3 shows a top-down view of the stowable hook assembly 30, with the U-shaped crossbar 32 and lateral end portions 36 in the same plane, and with the hook portions 34 perpendicular to the crossbar. The hook portions 34, in accordance with one or more aspects, are welded to the crossbar at the bottom portion or the U-shape approximately 80 mm to approximately 90 mm apart from each other. In one particular example the hook portions 34 are approximately 85 mm apart, and the length of the bottom portion of the U-shaped crossbar is approximately 90 mm. As stated above, the foregoing examples are presented for illustrative purposes and are not intended to limit the dimensions of the assembly 30 or the components thereof and/or associated therewith.

FIG. 4 illustrates an askew view of the bedrail hook assembly 30. The assembly includes the crossbar 32, having a substantially U-shaped configuration, with hook portions 34 welded thereto. The crossbar additionally has lateral end portions 36 that can be inserted into a mounting bracket and which are oriented along the pivot axis of the assembly. That is, once mounted to a portable device, such as a bedside patient monitor or the like, the assembly pivots about an axis that extends through the lateral end portions of the crossbar to permit the assembly to be stowed in an integral handle of the potable device, such as the handle cavity 14 described above, as well as to be pivoted approximately ISO degrees out and up from the handle to function as a bedrail hook to secure the portable device to a bedrail or similar structure.

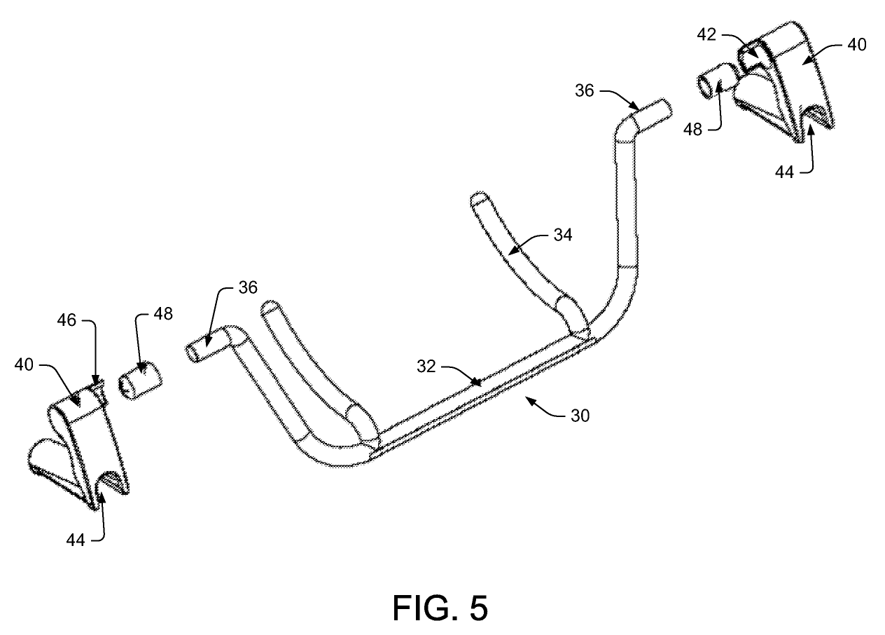

FIG. 5 is an exploded view of the stowable bedrail hook 30 and mounting bracket 40, with which the hook assembly is mounted to a portable device. The hook assembly 30 includes the U-shaped crossbar 32 with hook portions 34 for securing a portable device to a bedrail or other structure and lateral end portions 36 about which the assembly 30 pivots. The mounting bracket 40 includes a hook assembly-receiving hole 42 into which a lateral end 36 of the hook assembly is inserted, as well as a screw hole that receives a screw to secure the mounting bracket to the portable device. According to some examples, the portable device is designed with screws that secure a back side of the portable device casing to an internal device frame. For instance, the internal device frame, to which device components are attached, can include one or more threaded bores that receive screws or bolts to secure one or more sides of the device casing. Such screws may additionally be counter-sunk into the casing, if desired. The mounting bracket 40 is inserted into such a recess in the back side of the device casing, and a screw is inserted into the screw hole through the mounting bracket and back side of the casing into a threaded screw-receiving bore to secure the mounting bracket to the portable device.

The hook assembly-receiving hole 42 optionally has a cut-out flange 46 that stops the hook assembly 30 from rotating past a 180-degree point when mounted on the portable device and pivoted out from its stowed position in a device handle cavity. In this manner, the device to which the assembly is mounted is secured to a bedrail because the device cannot rotate backward (e.g., into the bedrail) and cannot rotate forward due to the abutment of the hook assembly against the flange. According to other embodiments, the hook assembly receiving holes 42 are formed directly in the lateral walls of the handle cavity 14 near the top of the handle cavity aperture on the back side 18 of the device. In this example, grooves may be formed that extend through the surface of the back side of the device from the handle cavity aperture to the top surface of the device. The grooves can be formed to receive the crossbar in order to permit the hook assembly 30 to pivot all the way to the active position (e.g., approximately 180 degrees from the stowed position).

In some embodiments, the lateral end portion 36 of the hook assembly is inserted into a bushing 48 to prevent undesired wear on the mounting bracket and/or the hook assembly during repeated pivoting and usage. For instance, in a case where the hook assembly is formed of stainless steel and the mounting bracket is formed of a less-dense material, such as aluminum, plastic, etc., the bushing 48 can prevent the assembly from wearing down or otherwise compromising the integrity of the mounting bracket material and/or shape. Additionally, the bushing can add friction, if desired, to assist in maintaining the hook assembly in its desired position. For instance, the bushing can be made of a rubber or rubber-like material so that the hook assembly remains snuggly stowed when placed in the stowed position. The bushing, in this case, is designed to have a relatively high moment of static friction, but one which is easily overcome by a small amount of force, such as may be applied by a human finger.

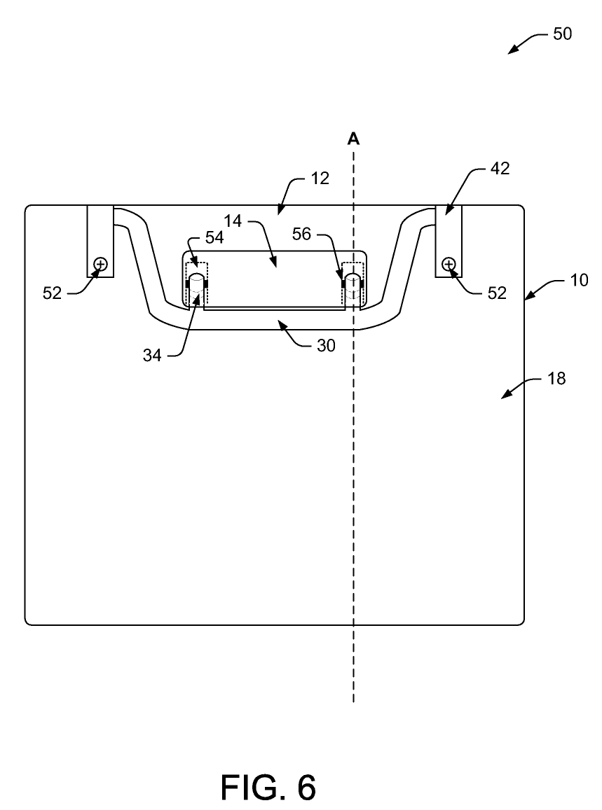

FIG. 6 shows a rear-view of a system 50 including the stowable bedrail hook assembly 30 mounted to the portable device 10 using the mounting brackets 42. The portable device 10 has a handle 12 that is integral to the device, and which defines a handle cavity 14 that accommodates a human hand when carrying the device. The handle cavity 14 extends through the top of the device and through the back side 18 of the device. The hook assembly 30 is mounted in the mounting brackets 42, which are in turn affixed to the back side of the device by screws 52. The crossbar portion of the hook assembly rests flush against the back side of the device, while the hook portions 34 of the assembly extend into the cavity 14 to for out-of-the-way storage that facilitates minimizing device size and space occupation.

The hook portions 34 of the assembly are designed to be substantially congruent to the interior of the cavity 14 in which the hook portions rest when stowed. In this manner, the hook portions fit neatly into the cavity without obstructing the cavity so that a hand is easily inserted into the cavity to grasp the handle 12 when the hook assembly is stowed. Additionally or alternatively, the cavity is designed with additional hook recesses 54 that permit the hook portions 34 to penetrate beyond the interior wall of the cavity, e.g., in the event that the hook portions are designed with arcs that are not congruent to an arc or shape of the cavity. Additionally, the hook recesses 54 can include a pair of retaining humps 56 that facilitate securing the assembly in the stowed position. For instance, the hook recesses a designed to be slightly wider than the hook portions to accommodate the hook portions. The retaining humps can be placed on both interior sides of a recess to narrow the width of the recess at the location of the humps. The space between the humps is slightly narrower than the width of the hook portion, so that the hook portion can be slightly forced resiliently past the humps into a retained position.

It will be understood that the device casing, handle, walls of the handle cavity, hook recesses, retaining humps, etc., may be made from similar or identical materials, including but not limited to plastics, metals, etc. Additionally, hook recesses 54 can be designed to exhibit slight flexibility in a lateral direction so that the hook portions can be snapped into place and retained in the stowed position. Moreover, the retaining force provided by the retaining humps 56 is relatively small so that it is sufficient to retain the hook assembly in a stowed position but is easily overcome by the force generated by a finger or hand when removing the assembly from the stowed position.

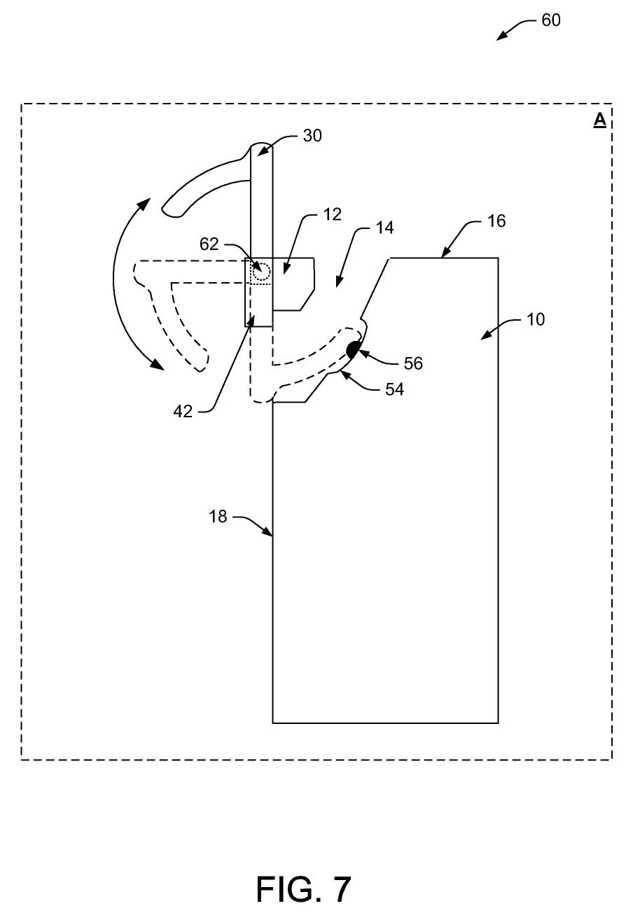

A section line “A” is illustrated to define a cutting plane that extends into the page of FIG. 6, and the plane defined by line A is shown in greater detail in the cross-sectional view of FIG. 7, below.

FIG. 7 is a cross-sectional view 60 of the portable device 10 and mounted hook assembly 30. A portable device 10 (e.g., a portable patient monitoring device, a television, a radio, an ECG machine, a portable defibrillator, a portable respirator, etc.) has an integral handle 12 and an associated integral handle cavity 14 that extends through the device and has cavity apertures at a top side 16 of the device and at a back side 18 of the device. The hook assembly 30 is shown in a “pivoted-out,” or active position, as well as in varied other positions including a transitional position and a stowed position. The hook assembly is mounted to the device using the mounting brackets 42 described above, and pivots or rotates between the active and stowed positions about a pivot axis 62 that extends into the page through the lateral crossbar ends (not shown) of the hook assembly.

The handle cavity 14, in some embodiments, includes hook recesses 54 to accommodate the hook portions of the assembly 30. The recesses can additionally include, in one or more aspects a pair of laterally-positioned retainer humps 56 that retain the assembly in a stowed position once the hook portions have been forced past the retainer humps 56. As shown, the hook portions of the assembly 30 are substantially congruent to the interior surfaces of the handle cavity 14. Although the surfaces of the handle cavity are shown as a plurality of straight, intersecting planes, it will be understood that the cavity can surfaces can include one or more continuous curved surfaces that are substantially similar or identical to the curvature of the hook portion of the assembly. In such cases, the retainer humps 56 can be located directly on the surface of the cavity wall, when hook recesses 54 are not employed. For example, the casing of the device can be formed of molded plastic, in which case the handle, handle cavity, optional hook recesses and retainer humps, etc., fare formed as a continuous and integral surface that is easily sanitized. That is, by designing the handle, cavity, and other components of the device casing as a single molded structure, undesirable bacterial growth opportunities can be minimized since the cavity can be thoroughly sanitized using a disinfectant spray, wipe, or the like. Additionally or alternatively, the handle cavity 14 can be lined by a curved, tubular sleeve.

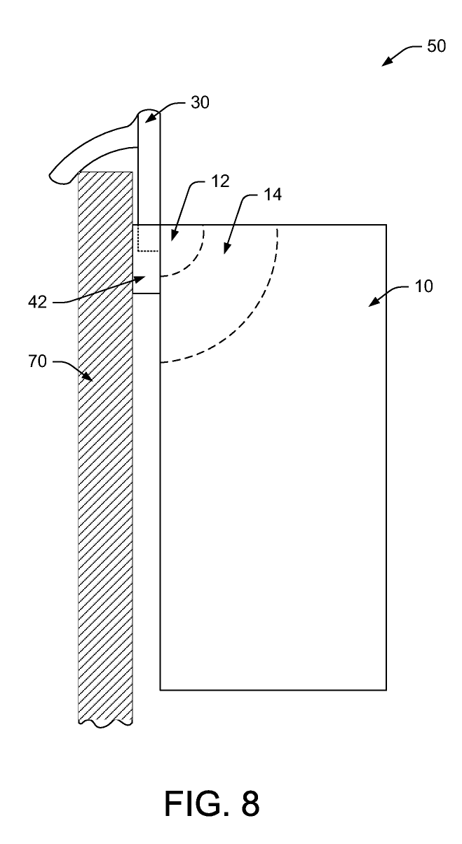

FIG. 8 illustrates a side-view of the portable device 10 with mounted hook assembly 30 in an active position and secured to a structure 70, such as a bedrail or the like. The system 50 includes any and/or all of the previously-described components. However, for brevity's sake the system is illustrated as showing the portable device 10 with the integral handle 12 and handle cavity 14 (shown in dashed lines) with the hook assembly 30 mounted to the device using the mounting brackets 42. The hook assembly 30 rests atop the structure 70, and the weight of the device 10 causes the device to hang securely against the structure. Typical bedrails on a hospital bed or the like are formed as solid plates, grids of rails, etc., such that mounting the hook assembly 30 on the back of the device permits the device to rest securely against a plate or grid-type bedrail, whereas placing the hook in the middle of the top of the device would not necessarily permit the device to be securely positioned.

In this embodiment, the cavity 14 is lined by a tubular sleeve that extends along a quadrant of a circle. The hook assembly pivots about a center of the circle defined by the inner surface of the outer wall of the sleeve. The hook portion 34 is curved along a circular arc segment of the same or approximately the same radius as the inner surface of the outer sleeve wall. The hook portion is mounted at the same radial distance from the center of rotation, such that the hook portion 34 is received in the sleeve with its outer surface extending along the inner surface of the sleeve. Further, the hook portions are, in one embodiment, received at the extreme side ends of the sleeve to minimize interaction with a hand inserted into the sleeve.

It will be appreciated that, according to other embodiments, the hook assembly 30 mounted using mounting brackets 40 on a device that does not employ the integral handle 12 and handle cavity 14 described above. In this example, the hook portions 34 can stow away in hook-receiving bores provided in the back side of a device, wherein the bores are formed with an appropriate curvature to receive the hook portions 34. For example, the hook portions and bore extend along a circumference of a circle whose radius matches the radial distance of the hook portions from the pivot axis of the hook assembly.

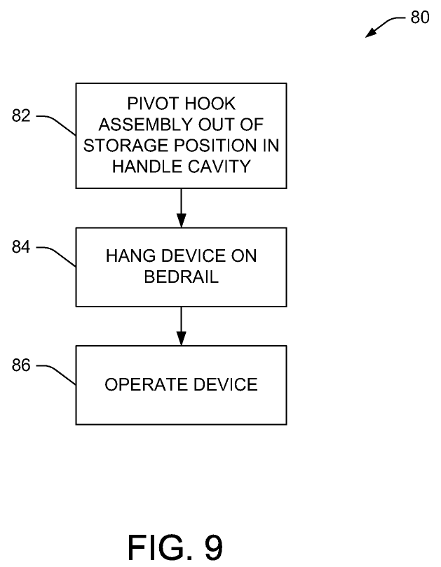

FIG. 9 illustrates one or more methods related to employing a stowable hook assembly for a portable device to secure the portable device to a structure, in accordance with various features. While the methods are described as a series of acts, it will be understood that not all acts may be required to achieve the described goals and/or outcomes, and that some acts may, in accordance with certain aspects, be performed in an order different that the specific orders described.

FIG. 9 illustrates a method 80 for operating the system 50. At 82, the hook assembly is pivoted out of its stowed position in the handle cavity of the device. Once the hook assembly is rotated outward to a position approximately 180 degrees from the stowed position, the device is hung from a structure, at 84. When the device is securely hung from the structure, the device is connected with the patient and operated, at 86. After user, the device is disconnected from the patient, lifted off the bedrail, the hook pivoted to the stowed position, and the device carried to another location. The monitor is cleaned and sanitized, any consumables replaced, and carried to another patient's bedside where the process is repeated.

According to some aspects, the device is a portable patient monitor and the structure is a patient's bedrail. In this example, the bedrail can be formed of metal or molded plastic, as is known by those of skill. In order to facilitate quickly connecting and operating the portable patient monitor while keeping the monitor size small to minimize space occupied by the monitor at the patient's bedside, the device is formed with the integral handle and stowable hook assembly. Thus, when needed, the stowable hook is pivoted out from its stowed position and placed over the top of the bedrail. The weight of the monitor exerts a downward force to maintain the monitor and hook assembly in the desired position, and the monitor rests suspended flat against the bedrail. The monitor may then be connected to the patient. When the monitor is no longer needed, it is simply lifted off of the bedrail and the hook is pivoted into its stowed position in the handle cavity.

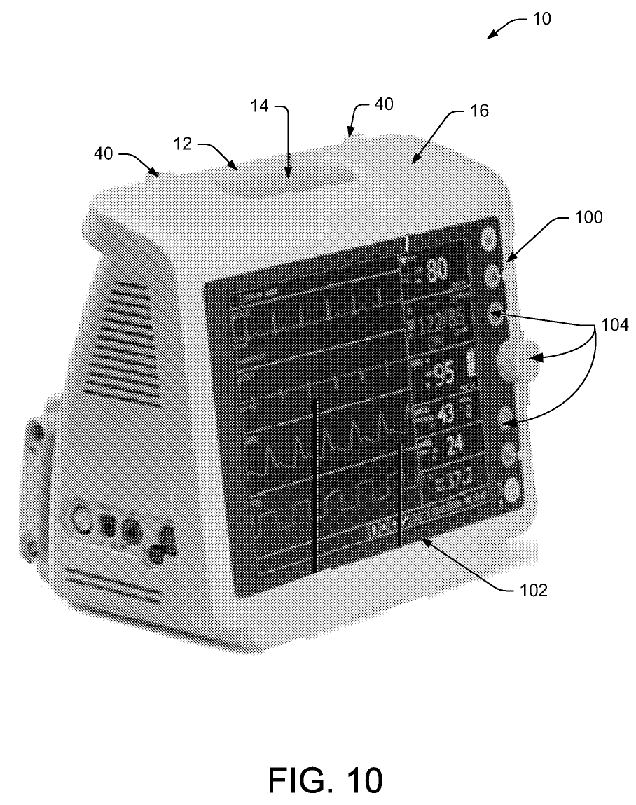

FIG. 10 is an illustration of a portable patient monitor 10 with integral handle 12, such as can be employed in conjunction with the hook assembly described above. The monitor 10 comprises the integral handle 12, which is formed into the casing of the device to define a handle cavity 14 that extends through a top side 16 of the monitor 10 and out a back side (not shown). Also partially visible extending upward form their mounted positions on the back side of the device are mounting brackets 40 that secure the hook assembly to the device. The patient monitor 10 is shown from an angled front-view, with a front side 100 and a screen that displays information to a user. For instance, the screen can display vital sign information related to a patient to whom the monitor 10 is connected. The monitor 10 also has a plurality of control components 104, such as buttons, knobs, and the like, which are employed by a user to select information for viewing, to manipulate a given view of the screen, etc. It will be appreciated that the monitor 10 can monitor any and all suitable or desired patient-related conditions, including but not limited to blood pressure, temperature, heart rate, SpO₂, exhaled CO₂, blood-glucose levels, electrocardiogram (ECG) related information, etc.

Having thus described the preferred embodiments, the invention is now claimed to be:

1. A system for supporting a portable monitoring device on a patient's bedrail, including:
a portable patient monitoring device;
an integral handle formed within a casing of the portable patient monitoring device;
a handle cavity that receives a human hand, the handle cavity extending through a top side of the portable patient monitoring device, around a quadrant of the handle through the device, and through a back side of the portable patient monitoring device to permit an operator to grasp the handle.

2. The system according to claim 1, further including a stowable bedrail hook assembly that includes a U-shaped crossbar and at least one hook portion.

3. The system according to claim 2, wherein the hook assembly further includes a lateral end portion at each end of the crossbar.

4. The system according to claim 3, further including a pair of mounting brackets that are secured to the back side of the portable patient monitoring device at each side of the handle cavity, wherein each mounting bracket includes a hook assembly receiving hole that receives a respective lateral end portion of the crossbar.

5. The system according to claim 4, further including a bushing mounted between the lateral end portion of the hook assembly and the mounting bracket.

6. The system according to claim 2, wherein the hook assembly is mounted to pivot about an axis extending through lateral end portions of the hook assembly.

7. The system according to claim 6, wherein the at least one hook portion is curved to be substantially congruent to the interior of the handle cavity.

8. The system according to claim 7, wherein the at least one hook portion stows in the handle cavity and the crossbar rests against the back side of the portable patient monitoring device when the hook assembly is in a stowed position.

9. The system according to claim 8, further including at least one pair of retaining humps between which the at least one hook portion is secured when in the stowed position.

10. The system according to claim 6, wherein the at least one hook portion is mounted a fixed radius from the pivot axis, the at least one hook portion and another surface of the handle cavity being curved to extend along segments of a circle of the fixed radius, such that when the at least one hook portion is pivoted into the handle cavity, it lies flush along the surface of the handle cavity.

11. The system according to claim 2, wherein the hook assembly is pivoted outward from the handle cavity to a position approximately 180 degrees from a stowed position, such that the crossbar is substantially perpendicular to the top side of the portable patient monitoring device.

12. The system according to claim 11, further including a flange on each mounting bracket, wherein the flange impedes the crossbar from pivoting beyond approximately 180 degrees from the stowed position.

13. The system according to claim 2, wherein the hook assembly is formed of stainless steel.

14. The system according to claim 2, wherein the hook assembly is formed of stainless steel wire that has a diameter of approximately ⅛ inch to approximately ⅜ inch.

15. The system according to claim 2, wherein the hook assembly is coated.

16. The system according to claim 2, wherein the hook assembly includes two hook portions disposed adjacent opposite ends of the handle cavity.

17. The system according to claim 2, wherein the hook assembly is formed of molded plastic.

18. The system according to claim 2, wherein the hook assembly is formed of molded plastic that has a diameter of approximately ⅛ inch to approximately ⅜ inch.

19. A method of deploying the portable patient monitoring device according to claim 2, including:
carrying the portable device with the hook assembly stowed in the handle cavity;
pivoting the hook assembly outward from the handle cavity; and
placing the hook over a structure to hang the portable patient monitoring device.

20. The method according to claim 19, further including returning the hook assembly to a stowed position when the portable patient monitoring device is no longer in use.

21. The method according to claim 19, wherein the structure is a bedrail on a bed in which the patient to be monitored by the portable patient monitoring device.

22. A system that facilitates securing a portable device to a structure, including:
means for carrying the portable monitoring device, the means for carrying being integral to the device;
means for hanging the device from a structure; and
means for pivotally securing the means for hanging to the portable monitoring device, such that he means for hanging is stored in the means for carrying when not in use and pivoted outward to an active position for use.
